(19) United States
(12) Patent Application Publication
(10) Pub. No.: US 2009/0238026 A1
(43) Pub. Date: Sep. 24, 2009

(54) IN-CAB CONTROL SYSTEM FOR A FRONT DISCHARGE CONCRETE TRUCK

(75) Inventor: Michael W. Johnson, Roanoke, IN (US)

Correspondence Address: BAKER & DANIELS LLP;111 E. WAYNE STREET, SUITE 800, FORT WAYNE, IN, 46802, US

(73) Assignee: TEREX ADVANCE MIXER, INC., Westport, CT (US)

(21) Appl. No.: 12/408,964

(22) Filed: Mar. 23, 2009

Related U.S. Application Data
(60) Provisional application No. 61/038,912, filed on Mar. 24, 2008.

(51) Int. Cl. B28C 7/16

(52) U.S. Cl. 366/43

(57) ABSTRACT

A control system for a front discharge concrete truck including a joystick positioned within a cab of the truck. In one embodiment, the joystick to connect to both a secondary shift selector and a chute controller. The secondary shift selector is connected to the truck's transmission. By actuating the secondary shift selector, the operator of the truck is capable of placing the truck's transmission in one of a forward condition, a reverse condition, and a neutral condition, without removing the driver's hand from the joystick. Similarly, the chute controller is connected to a discharge chute of the truck to direct the placement of concrete being offloaded from the truck. Thus, substantially concurrently with placing the transmission into one of a forward condition, a reverse condition and a neutral condition, the operator may actuate the joystick to correspondingly actuate the position of the discharge chute via the chute controller.

### BACKGROUND

1. Field of the Invention

The present invention relates to front discharge concrete trucks and, particularly, to control systems for front discharge concrete trucks.

2. Description of the Related Art

Front discharge concrete trucks are utilized to mix, deliver, discharge, and place concrete at a jobsite. In order to facilitate the proper placement of the concrete, the operator of the concrete truck is provided with a series of controls that operate various functions of the truck. For example, in order to properly place the concrete, the operator may be provided with controls for the discharge of concrete, movement of the discharge chute, and movement of the truck itself. Specifically, in order to control the placement of the concrete, the operate will need to actuate foot petals that control the throttle of the truck's engine, rotate a steering wheel to alter the direction of the truck, actuate a gear shift that controls the trucks transmission, and actuate a chute control to direct movement of the discharge chute.

However, due to the number of controls that must be actuated by the operator during the placement of concrete at a jobsite, the operator is unable to substantially simultaneously actuate all of the controls. Thus, the operator is forced to release at least one of the controls in favor of actuating another of the controls. For example, since each of the steering wheel, gear shift, and chute control are hand operated, the operator of the truck will at any given time have a hand removed from at least one of these three controls. As a result, the operator is incapable of substantially concurrently actuating all of the controls necessary to efficiently place concrete at a jobsite. As a result, the time required to properly place a load of concrete at a jobsite is increased and the ability of the operator to effectively place the concrete is hampered.

What is needed is an improvement over the foregoing.

### SUMMARY OF THE INVENTION

The present invention relates to front discharge concrete trucks and, particularly, to control systems for use with the same. In one exemplary embodiment, the control system of the present invention includes a joystick positioned within the cab of a concrete truck. In one embodiment, the joystick connects to both a secondary shift selector and a chute controller. The secondary shift selector is connected to the truck's transmission. By actuating the secondary shift selector, the operator of the truck is capable of placing the truck's transmission in one of a forward condition, a reverse condition, and a neutral condition, without removing the driver's hand from the joystick. Similarly, the chute controller is connected to a discharge chute of the truck to direct the placement of concrete being offloaded from the truck. Thus, substantially concurrently with placing the transmission into one of a forward condition, a reverse condition and a neutral condition, the operator may actuate the joystick to correspondingly actuate the position of the discharge chute via the chute controller.

Advantageously, by providing the operator with a joystick capable of controlling both the truck's transmission and the position of the discharge chute, the operator may place one hand on the joystick and utilize the other hand to steer the vehicle while substantially simultaneously utilizing the operator's feet to control the engine's throttle and/or brake. This allows the operator to more effectively place concrete at a desired location on a jobsite by providing the operator with all the controls necessary for affecting the placement of concrete without the need to reposition a hand and/or foot during the same.

In another exemplary embodiment, a drum condition selector is positioned on the joystick. By actuating the drum condition selector, a drum, which is positioned on a chassis of the concrete truck and which holds the concrete therein, is changed from one of a discharge condition and a charge condition to the other of the discharge condition and the charge condition. Specifically, when the drum is in the charge condition, the drum rotates in a direction that causes the concrete contained therein to remain within the drum. In contrast, when the drum is in the discharge condition, the direction of rotation of the drum is reversed from the charge condition and the concrete contained within the drum will begin to exit through a discharge opening and enter the discharge chute. With the concrete in this position, the operator may control placement of the concrete by actuating the joystick which, as described above, is connected to a chute controller.

In this embodiment, the operator is capable of substantially simultaneously changing the condition of the vehicle's transmission, the direction of rotation of the drum, and position of the discharge chute to properly place concrete at a jobsite. Advantageously, by coupling each of the chute control, drum control, and transmission control to a joystick, the need for the operator to remove their hand from the joystick to actuate any of these features is eliminated. As a result of the use of the joystick of this embodiment, in conjunction with known steering and engine throttle and brake controls, an operator is provided the access to every control necessary to facilitate the placement of concrete at a jobsite without the need to remove a hand and/or foot from any of the controls.

In one form thereof, the present invention provides a control device for a front discharge concrete truck. The truck includes an engine, a transmission coupled to the engine, the transmission having a forward condition, a reverse condition, and a neutral condition, a chassis supporting the engine and the transmission, a rotatable drum having a discharge opening positioned on the chassis, a chute configured to receive and direct material discharged from the drum through the discharge opening, and a cab positioned on the chassis substantially adjacent the discharge opening. The cab includes a driver's seat, a steering wheel, and a primary shift selector positioned therein, wherein the primary shift selector is actuatable to cause the transmission to enter one of the forward condition, the reverse condition, and the neutral condition and leave another of the forward condition, the reverse condition, and the neutral condition. The control device includes: a joystick positioned within the cab, the joystick moveable on at least two substantially orthogonal joystick axes; a chute controller connected to both the joystick and the chute, the chute controller operable to actuate the chute along at least two substantially orthogonal chute axes, the at least two substantially orthogonal chute axes corresponding to the at least two substantially orthogonal joystick axes, wherein actuation of the joystick along either of the at least two substantially orthogonal joystick axes results in corresponding actuation of the chute; and a secondary shift selector positioned on the joystick, the secondary shift selector connected to the transmission, wherein actuation of the secondary shift selector results in the transmission entering one of the forward condition, the reverse condition, and the neutral condition and leaving another of the forward condition, the reverse condition, and the neutral condition.

In another form thereof, the present invention provides a front discharge concrete truck, including: an engine; a transmission coupled to the engine, the transmission having a forward condition, a reverse condition, and a neutral condition; a chassis supporting the engine and the transmission; a rotatable drum mounted on the chassis for holding concrete, the drum having a discharge opening, a discharge condition, and a charge condition, whereby, in the discharge condition, the drum discharges concrete through the discharge opening; a chute configured to receive and direct concrete discharged from the drum through the discharge opening; a cab positioned on the chassis substantially adjacent to and below the discharge opening; a driver's seat positioned within the cab; a steering wheel positioned within the cab; a primary shift selector positioned within the cab, the primary shift selector connected to the transmission, wherein the primary shift selector is actuatable to cause the transmission to enter one of the forward condition, the reverse condition, and the neutral condition and leave another of the forward condition, the reverse condition, and the neutral condition; a joystick positioned within the cab, the joystick moveable on at least two substantially orthogonal joystick axes; a chute controller connected to both the joystick and the chute, the chute controller operable to actuate the chute along at least two substantially orthogonal chute axes, the at least two substantially orthogonal chute axes corresponding to the at least two substantially orthogonal joystick axes, wherein actuation of the joystick along either of the at least two substantially orthogonal joystick axes results in corresponding actuation of the chute; and a secondary shift selector positioned on the joystick, the secondary shift selector connected to the transmission, wherein actuation of the secondary shift selector results in the transmission entering one of the forward condition, the reverse condition, and the neutral condition and leaving another of the forward condition, the reverse condition, and the neutral condition.

In yet another form thereof, the present invention provides a control system for a front discharge concrete truck, the truck including an engine, a transmission coupled to the engine, the transmission having a forward condition, a reverse condition, and a neutral condition, a chassis supporting the engine and the transmission, a rotatable drum having a discharge opening positioned on the chassis, a chute configured to receive and direct material discharged from the drum through the discharge opening, and a cab positioned on the chassis substantially adjacent to the discharge opening. The cab includes a driver's seat, a steering wheel, and a primary shift selector positioned therein, wherein the primary shift selector is actuatable to cause the transmission to enter one of the forward condition, the reverse condition, and the neutral condition and leave another of the forward condition, the reverse condition, and the neutral condition. The control system including: a joystick positioned within the cab, the joystick moveable on at least two substantially orthogonal joystick axes; a chute controller electronically connected to the joystick, the chute controller operable to actuate the chute along at least two substantially orthogonal chute axes, the at least two substantially orthogonal chute axes corresponding to the at least two substantially orthogonal joystick axes, wherein actuation of the joystick along either of the at least two substantially orthogonal joystick axes results in the joystick sending an electronic signal to the chute controller causing the chute controller to correspondingly actuate the chute in accordance with the electronic signal received from the joystick; a transmission control module connected to the transmission, wherein the transmission control module actuates the transmission to enter one of the forward condition, the reverse condition, and the neutral condition and leave another of the forward condition, the reverse condition, and the neutral condition; and a secondary shift selector positioned on the joystick, the secondary shift selector electronically connected to the transmission control module, wherein actuation of the secondary shift selector results in the secondary shift selector sending an electronic signal to the transmission control module and the transmission control module actuates the transmission to enter one of the forward condition, the reverse condition, and the neutral condition and leave another of the forward condition, the reverse condition, and the neutral condition in accordance with the electronic signal received from the secondary shift selector.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective view of a front discharge concrete truck;

FIG. 2 is a perspective view of the interior of the cab of the front discharge concrete truck of FIG. 1;

FIG. 3 is an enlarged, fragmentary prospective view of the cab of FIG. 3;

FIG. 4 is a schematic depiction of a control system according to one embodiment of the present invention;

FIG. 5 is a perspective view of several components of the schematic of FIG. 4 showing several connections therebetween;

FIG. 6A is a front, elevational view of the joystick of the control system of FIG. 5;

FIG. 6B is a side, elevational view of the joystick of the control system of FIG. 5;

FIG. 7A is a perspective view of the electronic control module of the control system of FIG. 5;

FIG. 7B is a plan view of the electronic control module of the control system of FIG. 5;

FIG. 7C is a side, elevational view of the electronic control module of the control system of FIG. 5 taken in the direction of line 7C-7C of FIG. 7B;

FIG. 7D is a side, elevational view of the electronic control module of the control system of FIG. 5 taken in the direction of line 7D-7D of FIG. 7B;

FIG. 8A is perspective view of the chute controller of the control system of FIG. 5;

FIG. 8B is another perspective view of the chute controller of the control system of FIG. 5;

FIG. 9 is schematic of a control system according to another exemplary embodiment;

FIG. 10 is schematic of a control system according to yet another exemplary embodiment;

FIG. 11 is schematic of a control system according to a further exemplary embodiment;

FIG. 12 is schematic of a control system according to another exemplary embodiment;

FIG. 13 is a partial plan view of an exemplary embodiment of a hydraulic chute control taken along line 13-13 of FIG. 1;

FIG. 14 is a partial cross-sectional view of an exemplary embodiment of a pneumatic control; and

FIG. 15 is a schematic depiction of the drum control system according to an exemplary embodiment.

Corresponding reference characters indicate corresponding parts throughout the several views. The exemplifications set out herein illustrate preferred embodiments of the invention and such exemplifications are not to be construed as limiting the scope of the invention in any manner.

### DETAILED DESCRIPTION

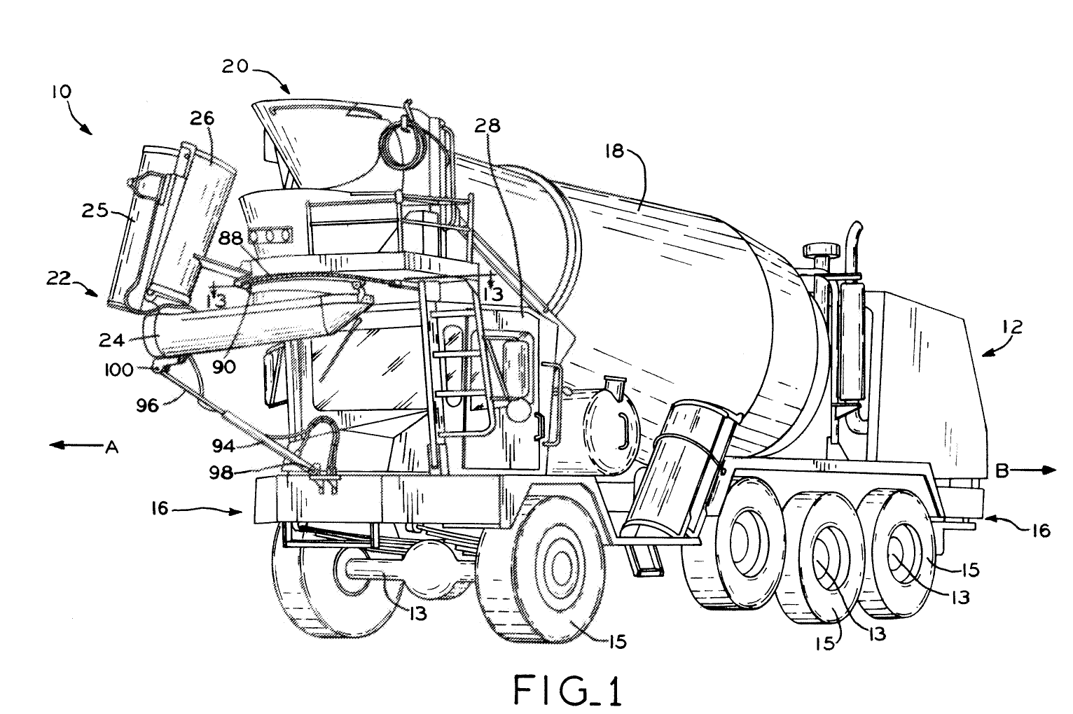

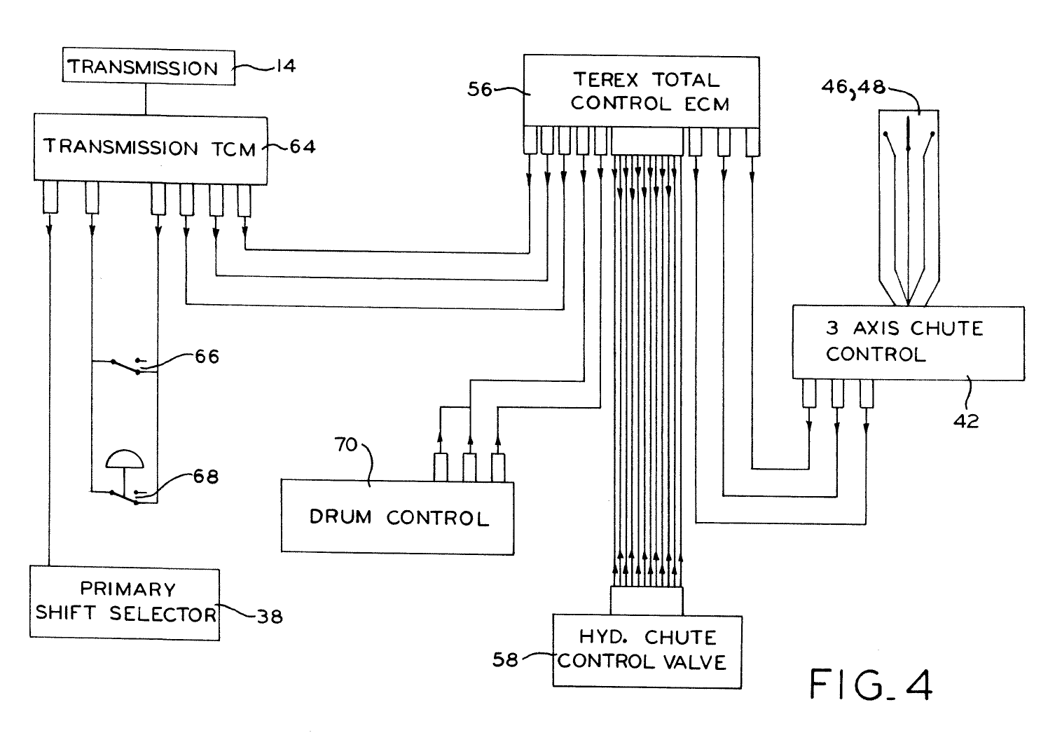

Front discharge concrete truck 10, shown in FIG. 1, includes engine 12 and transmission 14 (shown schematically in FIG. 4), which are supported by chassis 16. Engine 12 may be an internal combustion engine, for example, which is operated to provide power to truck 10. For example, operation of engine 12 delivers power to transmission 14, which may be in one of a forward condition, a reverse condition, and a neutral condition. The power provided to transmission 14 is then transferred to axels 13 and wheels 15, resulting in corresponding movement of truck 10. Specifically, when transmission 14 is in the forward condition, engine 12 generates power that is transmitted to transmission 14, and, correspondingly, axels 13 and wheels 15, to cause truck 10 to move in a forward direction, i.e., the direction of arrow A of FIG. 1. Alternatively, when transmission 14 is in the reverse condition, engine 12 generates power that is transmitted to transmission 14, and, correspondingly, axels 13 and wheels 15, to cause truck 10 to move in a reverse direction, i.e., the direction of arrow B of FIG. 1. Finally, when transmission 14 is in the neutral condition, engine 12 may transmit power to transmission 14, however no corresponding movement of truck 10 results.

As shown in FIG. 1, truck 10 also includes drum 18 mounted on chassis 16. Drum 18 is configured to be filled with concrete for the transportation of concrete to a jobsite. Additionally, drum 18 is rotatably mounted to chassis 16, such that drum 18 may be continually rotated along its longitudinal axis to help the concrete therein achieve the proper consistency and also to help prevent the concrete contained therein from setting. During operation of truck 10, drum 18 is placed in one of a charge condition and a discharge condition. When drum 18 is in the charge condition, drum 18 is rotating in the charge direction and the concrete remains contained within drum 18. In contrast, when drum 18 is in the discharge condition, drum 18 is rotated in the discharge direction, i.e., the direction opposite of the charge direction, and the concrete contained therein is discharged from drum 18 through discharge opening 20.

When drum 18 is in the discharge condition and concrete is exiting drum 18 through discharge opening 20, the concrete is directed to chute 22. As shown in FIG. 1, chute 22 includes three portions 24, 25, 26. While described and depicted herein as having three portions 24, 25, 26, chute 22 may, alternatively, be formed from a single portion, two portions, or, alternatively, may have a plurality of portions in excess of three. As shown in FIG. 1, chute 22 is in a folded condition, i.e., portions 25, 26 of chute 22 are in an upright position relative to portion 24 of chute 22, to prevent chute 22, and, specifically, portions 25, 26, from projecting outwardly from the front of truck 10. During the discharge of concrete from drum 18, chute 22 is placed in an unfolded condition (not shown), in which portions 24, 25, 26 are aligned with one another, to provide a discharge path for concrete exiting discharge opening 20.

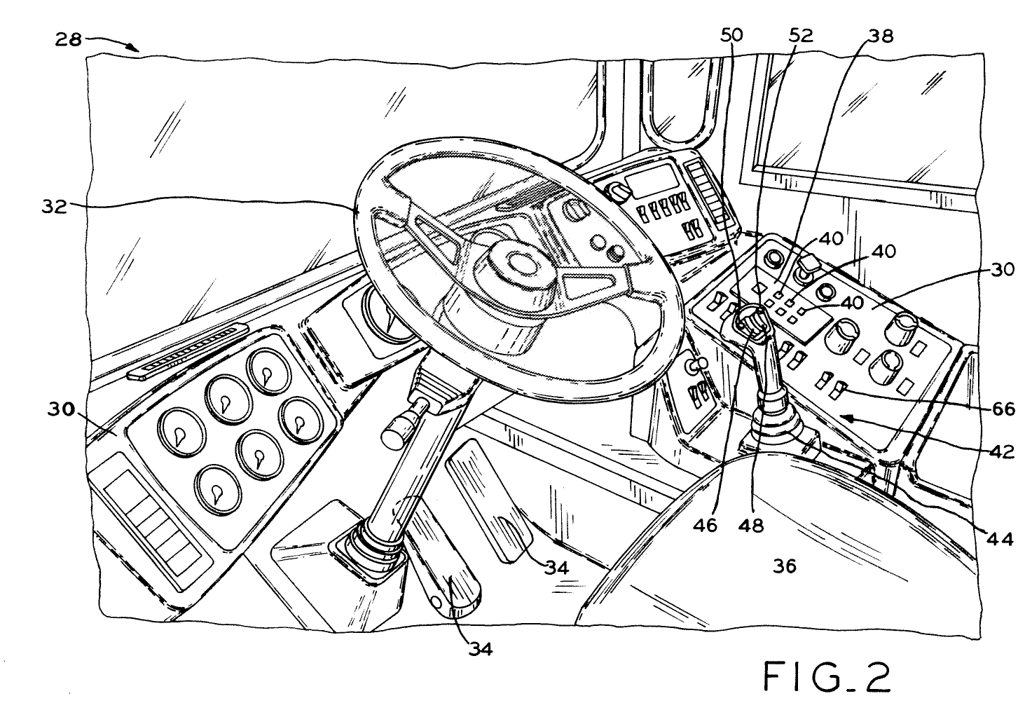

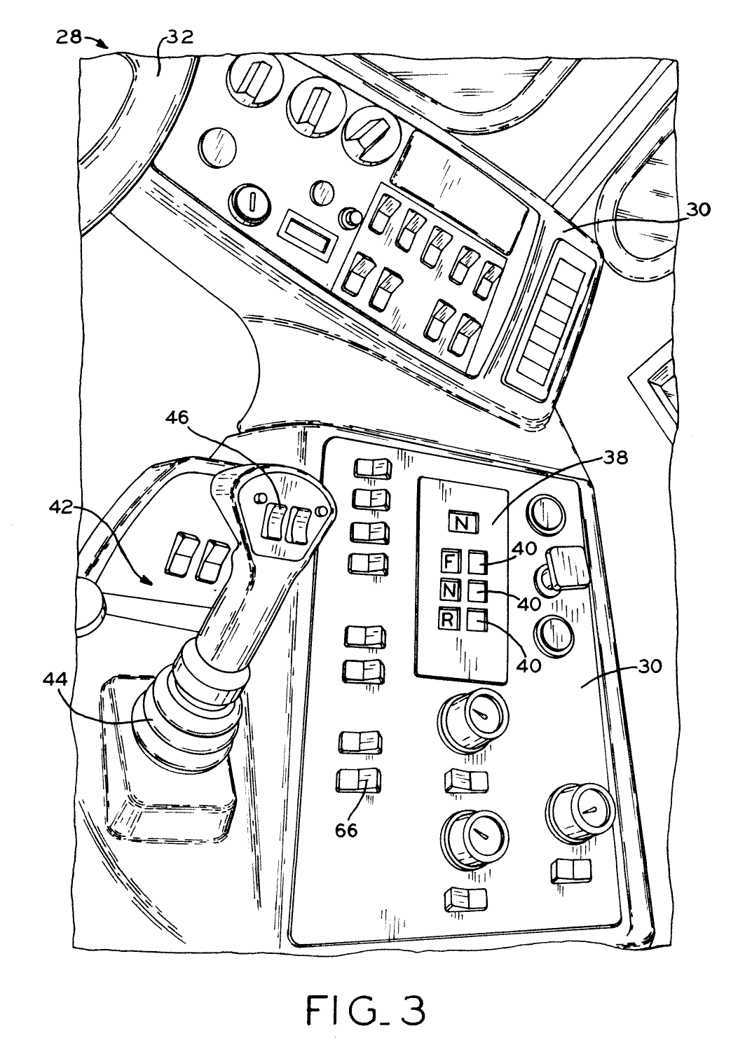

As shown in FIG. 1, cab 28 is also positioned on chassis 16 of truck 10. Cab 28 is occupied by an operator who controls the operation of truck 10 from within cab 28. Specifically, referring to FIGS. 2 and 3, cab 28 includes dashboard 30 having a plurality of controls positioned thereon, steering wheel 32, and foot pedals 34. For example, positioned within cab 28 on dashboard 30 are controls that may be desirable to facilitate the operation of truck 10, such as controls for an onboard water tank, a slump gage, and/or axle controls. Additionally, positioned within cab 28 is driver seat 36, which supports the operator while driving truck 10 or otherwise operating the same to place concrete at a jobsite.

Referring to FIGS. 1 and 3, steering wheel 32 is connected to wheels 15 in a known manner, such that rotation of steering wheel 32 causes corresponding rotation of wheels 15, and functions to allow the operator to steer truck 10 from within cab 28. Additionally, foot pedals 34 may include a throttle or gas pedal and a brake pedal, both of which operate in a traditional manner to control the throttle of engine 12 and the braking of truck 10, respectively. In order for the operator to control the direction of movement of truck 10, primary shift selector 38 is provided within cab 28. As shown in FIGS. 3 and 4, primary shift selector 38 may include a plurality of buttons 40 that may be depressed or otherwise actuated to place transmission 14 in one of the forward condition, the reverse condition, and the neutral condition and correspondingly cause transmission 14 to leave another of the forward condition, the reverse condition, and the neutral condition.

In one exemplary embodiment, primary shift selector 38 is also connected to a transmission control module 64 (FIG. 5), as discussed below, to control the operation of transmission 14. Primary shift selector 38 may be connected to transmission control module 64 in any manner, such as by an electronic connection. Alternatively, in another exemplary embodiment, primary shift selector 38 may be a lever or gear shift connected to transmission 14, either directly or indirectly, to cause transmission 14 to enter one of the forward condition, the reverse condition, and the neutral condition and leave another of the forward condition, the reverse condition, and the neutral condition. In this manner, by actuating primary shift selector 38, the operator may control operation of transmission 14 and, correspondingly, control the direction of movement of truck 10.

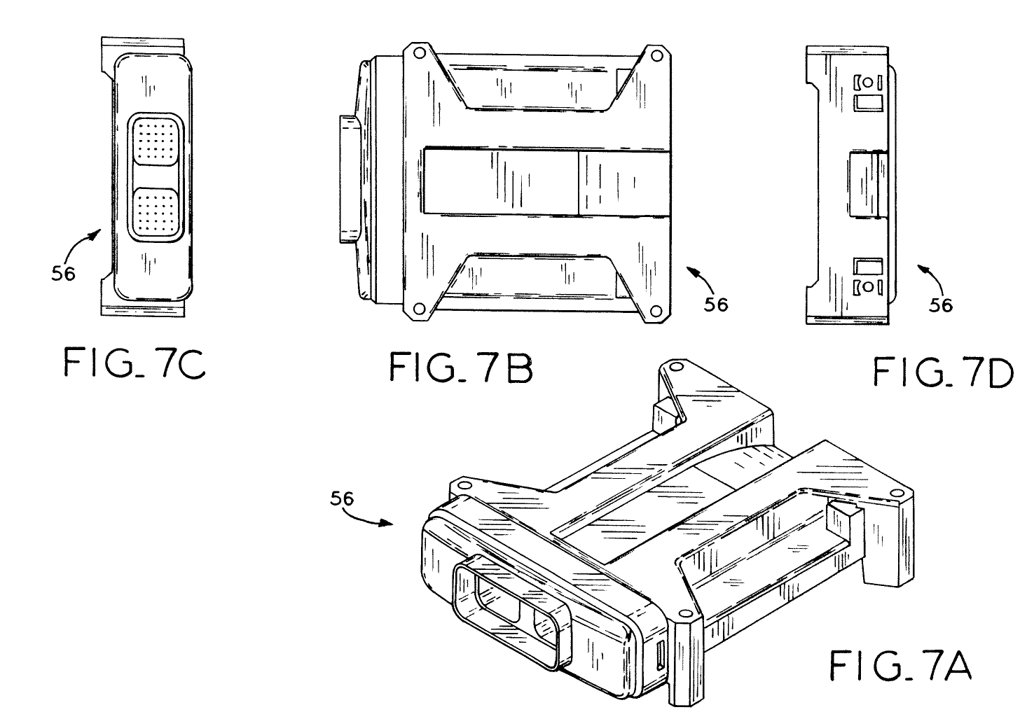

Further, in order to facilitate the placement of concrete at a jobsite, joystick 42 is provided within cab 28, as shown in FIGS. 2 and 3. Referring to FIGS. 2, 3, and 7A-7D, in one exemplary embodiment, joystick 42 is a control stick having Part Number 30869 and is commercially available from Terex Advance of Fort Wayne, Ind., a division of Terex Corporation. Joystick 42 is movable on at least two substantially orthogonal joystick axes. In a well known manner, movement of joystick 42 about the at least two substantially orthogonal joystick axes, results in corresponding movement of chute 22, as described in detail below. In one exemplary embodiment, joystick 42 comprises a lever, the entirety of which is movable along at least two substantially orthogonal joystick axes. Alternatively, in another exemplary embodiment, joystick 42 is secured at end 44 to form a pivot. Joystick 42 is then pivotable about end 44 on at least two substantially orthogonal joystick axes. As a result of the movement of joystick 42, chute 22 is correspondingly moved along at least two substantially orthogonal chute axes. For examples, chute 22 may be actuatable in an up/down direction along a first chute axis and in a left/right direction along a second chute axis.

Additionally, positioned on joystick 42 is secondary shift selector 46. In one exemplary embodiment, secondary shift selector 46 is a three-position momentary hall effect switch. Secondary shift selector 46 may be used as an alternative to primary shift selector 38 and allows the operator to place transmission 14 in one of the forward condition, the reverse condition, and the neutral condition and cause the transmission to leave another of the forward condition, the reverse condition, and the neutral condition in a substantially similar manner to primary shift selector 38. Advantageously, by providing secondary shift selector 46 on joystick 42, the operator of truck 10 is capable of changing the direction of movement of truck 10, while correspondingly changing the position of chute 22. As a result, the operator does not need to remove a hand from joystick 42 in order to actuate primary shift selector 38. Thus, the operator of truck 10 may substantially contemporaneously access all of the controls necessary to place concrete discharging from drum 18 through discharge opening 20 and onto chute 22 at a jobsite.

In one exemplary embodiment, joystick 42 further includes drum condition selector 48 positioned thereon. In one exemplary embodiment, drum condition selector 48 is a three-position momentary hall effect switch. Drum condition selector 48 is actuable to cause drum 18 to enter one of the charge condition and the discharge condition from the other of the charge condition and the discharge condition. For example, if drum 18 is in the charge condition, drum control selector 48 may be actuated to cause drum 18 to exit the charge condition and enter the discharge condition. In another exemplary embodiment, joystick 42 further includes chute condition switch 50, which causes chute 22 to fold and/or unfold as desired. Additionally, joystick 42 may include emergency stop switch 52, which, when actuated, causes rotation of drum 18 to substantially immediately stop. This allows the operator to substantially immediately stop the discharge of concrete from drum 18 or otherwise stop rotation of drum 18 to prevent damage to truck 10 or adjacent equipment and/or to prevent injury to other personnel on the jobsite. Furthermore, in one exemplary embodiment, joystick 42 includes an additional safety mechanism in the form of trigger control 54. Trigger control 54 is positioned on the underside of joystick 42 and must be depressed by the operator in order to engage joystick 42. Thus, unless trigger control 54 is depressed, joystick 42 will not function.

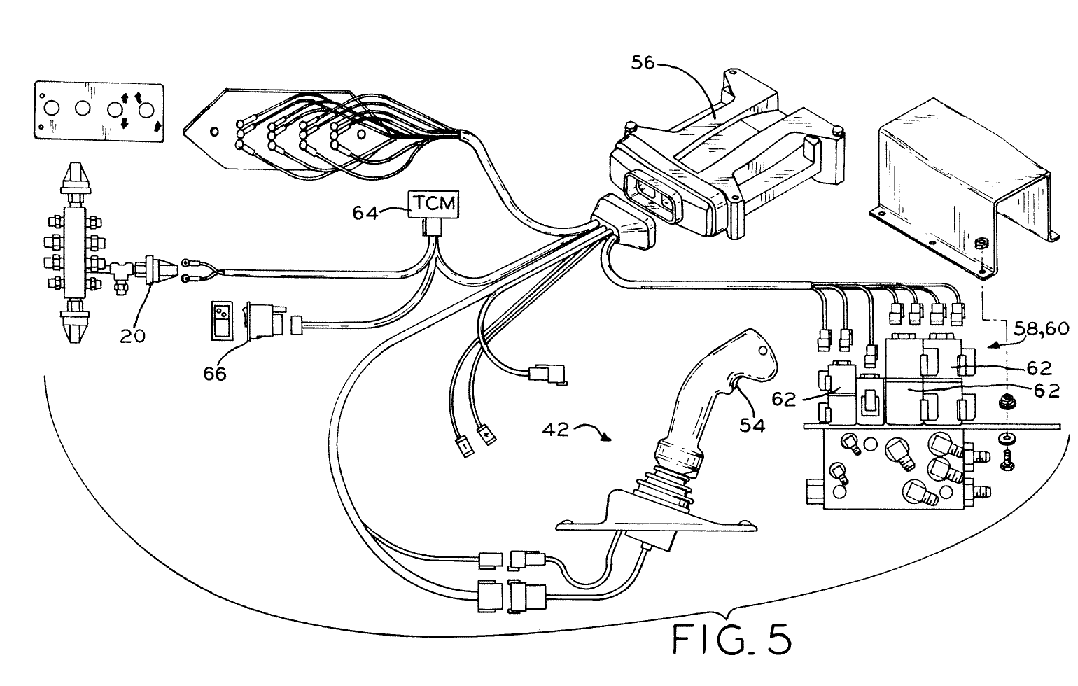

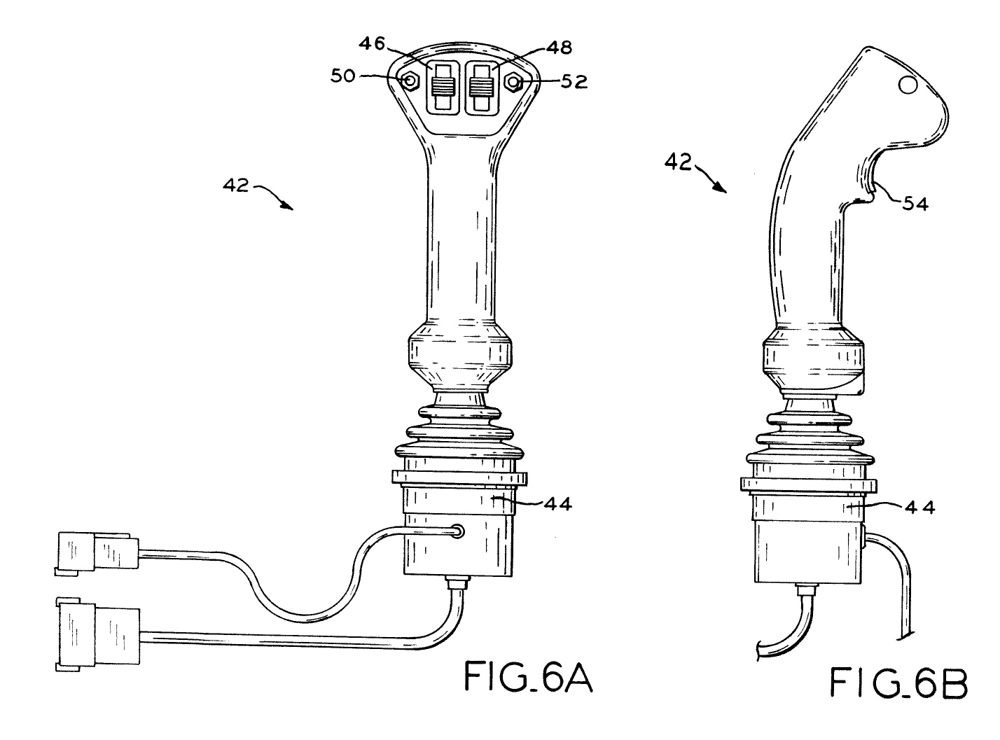

Referring to FIGS. 4-8B, the operation of joystick 42 and the corresponding control system is described in accordance with an exemplary embodiment. Specifically, referring to FIG. 5, the schematic of an embodiment of the control system including joystick 42 as shown. In this embodiment, joystick 42 is shown in electronic communication with an electronic control module 56. Electronic control module 56 is a generic computer control module that is capable of receiving input from a variety of electronic sources, processing the input in accordance with preloaded instructions in the form of computer readable code, and, in accordance with the preloaded instructions, providing an output in the form of an electrical signal to other control components or devices. The programming of an electronic control module like electronic control module 56 is well within the knowledge of one skilled in that art of programming controllers of this type. In one exemplary embodiment, electronic control module 56 is a generic electronic control module having Part Number 24282 and is commercially available from Terex Advance of Fort Wayne, Ind., a division of Terex Corporation. In this embodiment, electronic control module 56 functions as a hub that receives electronic signals from and delivers electronic signals to each of the corresponding components of the control system, as described in detail below. While described with specific reference to electronic control module 56, other exemplary control systems may be utilized in which electronic control module 56 is replaced or eliminated. For example, several different exemplary embodiments of control systems that operate without electronic control module 56 are described in detail herein.

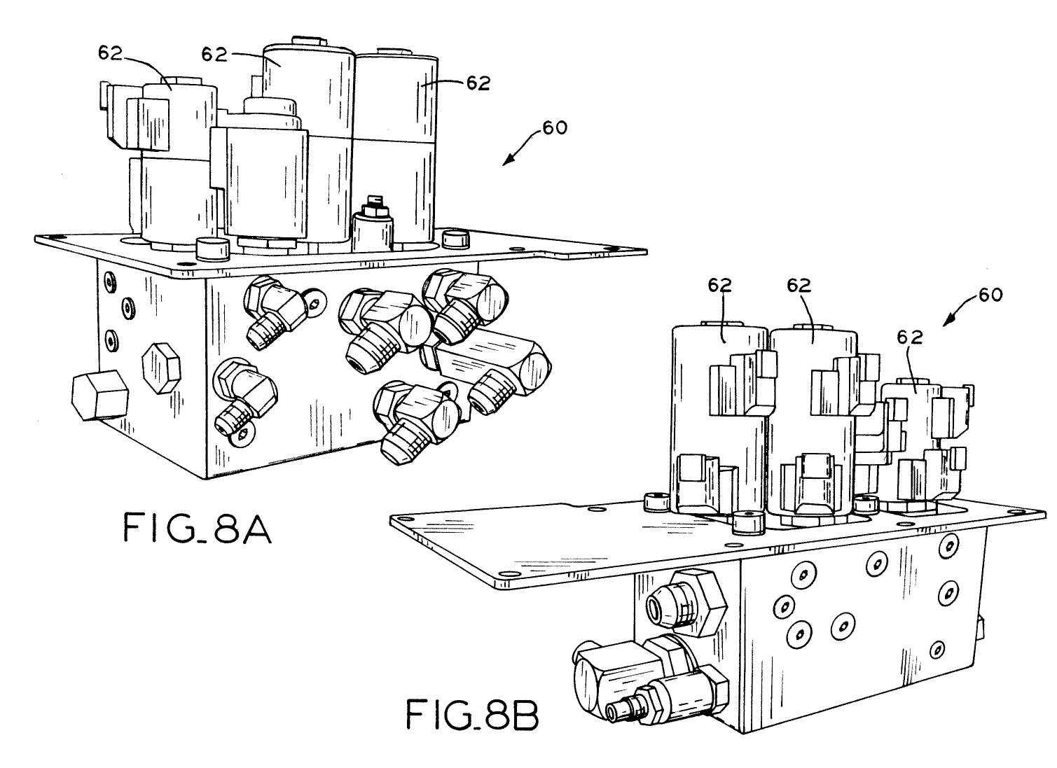

Electronic control module 56 receives signals from joystick 42 regarding the position of joystick 42 and the actuation of any selectors or switches positioned thereon. For example, the position of joystick 42 may be monitored by a hall effect sensor which electronically transmits signals to electronic control module 56 that correspond to the position of joystick 42. Based on the signals received by electronic control module 56 regarding the position of joystick 42, electronic control module 56 transmits to chute controller 58 electronic signals requesting movement of chute 22 into a position that corresponds to the position of joystick 42. For example, in one exemplary embodiment, chute controller 58 is an electric/hydraulic manifold assembly, such as assembly 60 shown in FIGS. 8A and 8B. In one exemplary embodiment, electronic/hydraulic manifold assembly 60 is an electronic/hydraulic manifold assembly having Part Number 24327 and is commercially available from Terex Advance of Fort Wayne, Ind., a division of Terex Corporation.

Assembly 60 is electronically connected to electronic control module 56 and hydraulically connected to chute 22. Thus, upon receipt of an electronic signal from electronic control module 56, motors, servomechanisms, and/or solenoids, for example, such as those identified at 62 in FIGS. 5, 8A, and 8B, may be actuated to control the flow of hydraulic fluid through manifold assembly 60. The resulting flow of hydraulic fluid causes movement of chute 22 that corresponds to the electrical signal received. Thus, based on the electronic signal received by manifold assembly 60 from electronic control module 56, chute 22 may be correspondingly moved along the at least two substantially orthogonal chute axes. In one exemplary embodiment, joystick 42 may be limited to movement along two substantially orthogonal joystick axes, so that chute 22 would be correspondingly limited to movement in one of an up/down and a left/right direction at any given time. In contrast, joystick 42 may be freely moveable about a plurality of joystick axes, such that chute 22 would be correspondingly moveable in a combination of the up/down and left/right directions at the same time. In another exemplary embodiment, movement of joystick 42 may result in proportional movement of chute 22. For example, if joystick 42 is moved one centimeter in a leftwardly direction, chute 22 may begin moving to the left at one inch per second. However, if joystick 42 is moved two centimeters in a leftwardly direction, chute 22 may begin moving to the left at four inches per second. Thus, in this embodiment, each incremental increase the movement of joystick 42 results in a substantially exponential increase in the movement of chute 22.

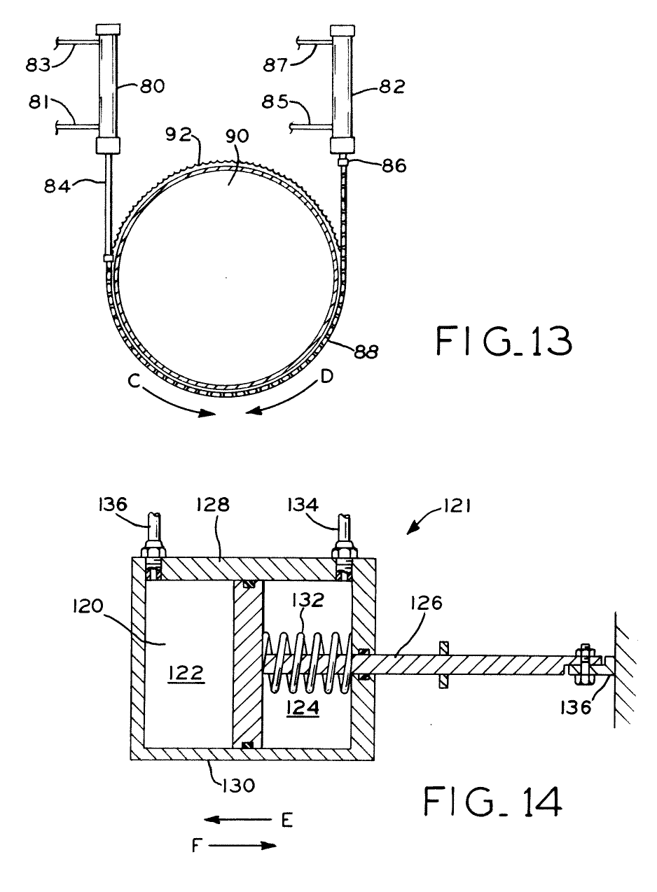

For example, referring to FIG. 13, upon receipt of an electronic signal from electronic control module 56, manifold assembly 60 may actuate motors, servomechanisms, and/or solenoids 62 to control to flow of hydraulic fluid to and from hydraulic cylinders 80, 82, which control the rotational movement of chute 22. Specifically, as shown in FIGS. 1 and 13, cylinders 80, 82 include pistons 84, 86, respectively, that are connected to opposing ends of chain 88. Chain 88 extends around sprocket 90 and engages teeth 92 on sprocket 90, such that movement of chain 88 results in corresponding rotation of sprocket 90. As shown in FIG. 1, chute 22 is secured to sprocket 90, such that rotation of sprocket 90 results in corresponding rotation of chute 22.

As indicated above, in order to rotate chute 22 in a first direction, electronic control module 56 may send an electric signal to manifold assembly 60 indicating that chute 22 should be rotated in a first direction. Upon receipt of the electronic signal, manifold assembly 60 actuates motors, servomechanisms, and/or solenoids 62 to cause hydraulic fluid to enter cylinder 82 through inlet 85 on a first side of piston 86 to cause piston 86 to retract into cylinder 82 and hydraulic fluid in cylinder 82 opposite piston 86 to exit cylinder 82 through outlet 87. As piston 86 retracts, piston 84 extends out of cylinder 80 causing hydraulic fluid to exit cylinder 80 through inlet 81 and enter cylinder 80 through outlet 87. Due to the retraction of piston 86 into cylinder 82, chain 88 is pulled in the direction of cylinder 82, which causes sprocket 90 to rotate in the direction of arrow C of FIG. 13.

Similarly, in order to rotate chute 22 in an opposite, second direction, electronic control module 56 may send an electric signal to manifold assembly 60 indicating that chute 22 should be rotated in the opposite, second direction. Upon receipt of the electronic signal, manifold assembly 60 actuates motors, servomechanisms, and/or solenoids 62 to cause hydraulic fluid to enter cylinder 80 through inlet 81 on a first side of piston 84 to cause piston 84 to retract into cylinder 80 and cause hydraulic fluid in cylinder 80 opposite piston 84 to exit cylinder 80 through outlet 87. As piston 84 retracts, piston 86 extends out of cylinder 82 causing hydraulic fluid to exit cylinder 82 through inlet 85 and enter cylinder 82 through outlet 87. Due to the retraction of piston 84 into cylinder 80, chain 88 is pulled in the direction of cylinder 80, which causes sprocket 90 to rotate in the direction of arrow D of FIG. 13.

In another exemplary embodiment, chute 22 is actuated by a gearbox (not shown) connected to a hydraulic motor. In this embodiment, opposing ends of chain 88 are connected to one another so that chain 88 forms a continuous loop. Chain 88 is engaged with teeth on sprocket 90, shown in FIG. 13, and with teeth on a sprocket driven by the gearbox. Thus, when manifold assembly 60 receives an electronic signal from electronic control modular 56, manifold assembly 60 supplies hydraulic fluid to the hydraulic motor that drives the gearbox. Rotation of the sprocket of the gearbox results in rotation of chain 88 and, correspondingly, sprocket 90 and chute 22.

In order to adjust the elevation of chute 22, electronic control module 56 may send an electric signal to manifold assembly 60 indicating that chute 22 should be raised or lowered. As shown, hydraulic cylinder 94 is pivotably and rotatably secured to frame 16 of truck 10 at a first end and is pivotably secured to chute 22 at a second end. Specifically, cylinder 94 is secured to frame 16 at pivot point 98 and piston 96 of cylinder 94 is secured to first section 24 of chute 22 at pivot point 100. Upon receipt of an electronic signal indicating that chute 22 should be raised and/or lowered, manifold assembly 60 actuates motors, servomechanisms, and/or solenoids 62 to cause hydraulic fluid to enter and/or exit hydraulic cylinder 94, shown in FIG. 1.

For example, when chute 22 is to be raised, hydraulic fluid is directed into an inlet in cylinder 94 on a first side of piston 96 and exits cylinder 94 through an outlet in cylinder 94 on an opposing, second side of piston 96 to cause piston 96 to extend from cylinder 94 in a known manner. As a result, cylinder 94 and piston 96 pivot about points 98, 100 and increase the elevation or raise first section 24 of chute 22 and sections 25, 26 of chute 22 that are supported by first section 24 as described above. Alternatively, when chute 22 is to be lowered, hydraulic fluid is directed into the outlet of cylinder 94 and exits cylinder 94 through the inlet in cylinder 94 to cause piston 96 to retract into cylinder 94 in a known manner. As a result, cylinder 94 and piston 96 pivot about point 98, 100 and decrease the elevation or lower first section 24 of chute 22 and sections 25, 26 of chute 22 that are supported by first section 24 as described above.

Additionally, while described and depicted herein with specific reference to a hydraulic connection, manifold assembly 60 may be connected to chute 22 by an electronic connection, a pneumatic connection, or a mechanical connection, for example. Furthermore, if joystick 42 includes chute condition switch 50 positioned thereon, joystick 42 may also be used to control the folding and/or unfolding of chute 22. For example, chute condition switch 50 may be connected to electronic control module 56. In this embodiment, the actuation of chute condition switch 50 will cause a corresponding electronic signal to be sent to electronic control module 56. Electronic control module 56 then processes the signal and relays a corresponding signal to manifold assembly 60 to actuate motors, servomechanisms, and/or solenoids 62. The actuation of motors, servomechanisms, and/or solenoids 62 causes a corresponding flow of hydraulic fluid to hydraulic cylinders connected to sections 24, 25, 26 of chute 22 that results in the actuation of chute 22 between one of a folded position and an unfolded position.

In addition, secondary shift selector 46, which is positioned on joystick 42, is also connected to electronic control module 56, which, in addition to primary shift selector 38 discussed above, is electronically connected to transmission control module 64, as shown in FIG. 4. Transmission control module 64 is operable connected to transmission 14 and controls the operation of transmission 14. For example, transmission control module 64 may include a central processing unit or CPU, which is loaded with computer readable code that controls the operation and shifting of transmission 14. In one exemplary embodiment, transmission control module 64 is an Allison transmission control module having part number A410098J, commercially available from Allison Transmission, Inc., of Indianapolis, Ind.

By connecting both primary shift selector 38 and secondary shift selector 46 via control module 56 to transmission control module 64, transmission control module 64 may receive commands from either primary shift selector 38 or secondary shift selector 46 and, thus, either primary shift selector 38 or secondary shift selector 46 may be used to control transmission 14. In order to alternate the control of transmission 14 between primary shift selector 38 and secondary shift selector 46, transmission shift select switch 66 is actuated. Thus, with transmission shift select switch 66 actuated to allow secondary shift selector 46 to control transmission 14, secondary shift selector 46 may be actuated to send an electronic signal to electronic control module 56 which, correspondingly, sends a signal to transmission control module 64. Based on the signal sent by secondary shift selector 46 to electronic control module 56, the signal sent by electronic control module 56 to transmission control module 64 results in transmission control module 64 causing transmission 14 to enter one of the forward condition, the reverse condition, and the neutral condition and leave another of the forward condition, the reverse condition, and the neutral condition. For example, if secondary shift selector 46 is actuated to place secondary shift selector 46 in a forward condition from a neutral condition, electronic control module 56 will receive an electronic signal from secondary shift selector 46 and transmit a corresponding signal to transmission control module 64, which will actuate transmission 14 to cause transmission 14 to leave the neutral condition and enter the forward condition.

Additionally, in one exemplary embodiment, in order to operate transmission 14 via secondary shift selector 46, pressure switch 68, shown in FIGS. 4 and 9-12, must also be activated. Pressure switch 68 is connected to transmission 14 and functions as a redundant safety mechanism. Specifically, pressure switch 68 is activated when the pressure of fluid in the transmission system lines is sufficient to indicate that the transmission has been placed into low gear. By utilizing pressure switch 68, an operator of truck 10 is prevented from controlling transmission 14 via secondary shift selector 46 during on-road operation of truck 10 at speeds in excess of those available in low gear. Thus, once the transmission is placed into low gear and transmission shift select switch 66 actuated, secondary shift selector 46 may be used to control transmission 14.

As shown in FIG. 4, drum condition selector 48, which is positioned on joystick 42, may also be connected to electronic control module 56. In this embodiment, actuation of drum condition selector 48 on joystick 42 results in the transmission of an electric signal from drum condition selector 48 to electronic control module 56. Electronic control module 56 then processes the signal and relays a corresponding signal to drum control 70, which is electronically connected thereto and which controls the rotation of drum 18. Specifically, in response to the signal received from electronic control module 56, drum control 70 causes actuation of drum 18 from one of the charge condition and the discharge condition to the other of the charge condition and the discharge condition. For example, if drum condition selector 46 is actuated to the discharge condition, a corresponding signal is sent to electronic control module 56, which sends a signal to drum control 70. Drum control 70 then actuates drum 18 from the charge condition to the discharge condition. In exemplary embodiments, drum control 70 may be an electronic/hydraulic manifold assembly, such as an electronic hydraulic manifold assembly similar to electronic hydraulic manifold assembly 60, or, alternatively, may be mechanically, pneumatically, electronically, or hydraulically connected directly to drum 18 or a corresponding control system therefore.

For example, referring to FIG. 15, an exemplary embodiment of drum control 70 is shown as drum control system 100 and includes electronic controller 101, which receives electronic signals from electronic control module 56. Upon receipt of electronic signals from electronic control module 56, electronic controller 101 is connected to hydrostatic pump 102 through electronic connection 103 and is configured to actuate motors, servomechanisms, and/or solenoids, such as proportional solenoids, to mechanically actuate a swash plate of hydrostatic pump 102. Hydrostatic pump 102 may be powered by engine 12 of truck 10 (FIG. 1), or may be powered in any other manner known in the art. Hydrostatic pump 102 is part of fluid circuit that includes hydraulic fluid tank 104, valve 106, and hydraulic motor 116.

Pump 102 is in fluid communication with tank 104 through hydraulic lines 108, 110. Tank 104 includes a reserve of hydraulic fluid which may be accessed by pump 102 and circulated through the fluid circuit. For example, when electronic controller 101 receives a command to place drum 18 (FIG. 1) in the charge condition, electronic controller 101 causes actuation of the swash plate of pump 102 in a first, charge direction. By actuating swash plate 102 in a first, charge direction, pump 102 will begin pumping hydraulic fluid through the fluid circuit. Specifically, with valve 106 closed, fluid pumped by pump 102 cannot travel through lines 108, 110 and return to pump 102. As a result, the hydraulic fluid is directed through hydraulic line 112, motor 116, and hydraulic line 114. Motor 116 is mechanically connected to gear box 118 and, as hydraulic fluid travels through motor 116, an output shaft of motor 116 rotates. The output shaft of motor 116 is connected to gearbox 118, which is, in turn, mechanically connected to drum 18. Thus, as the output shaft of motor 116 is rotated it transfers power to gearbox 118 and gearbox 118 causes drum 18 to rotate in a first direction that places drum 18 in the charge condition. In order to drive rotation of drum 18, gear box 118 may include a gear having teeth that mesh with corresponding teeth on a gear extending around the exterior of drum 18. Thus, as the gear of gearbox 118 rotates, it causes corresponding rotation of drum 18.

In one exemplary embodiment, when electronic controller 101 receives a command to place drum 18 in the discharge condition, the swash plate of pump 102 is actuated in a second, discharge direction, such that pump 102 pumps hydraulic fluid through hydraulic line 114, motor 116, and hydraulic line 112, respectively. By reversing the flow of hydraulic fluid through motor 116, the output shaft of motor 116 is rotated in the opposite direction. As a result, gearbox 118 and, correspondingly, drum 18 are also rotated in a reverse direction, placing drum 18 in the discharge condition.

Additionally, as indicated above, in the event that an emergency drum stop signal is received by electronic control module 56, electronic control module 56 relays an electronic signal to control system 101 of drum control 100. Control system 101 then actuates the swash pate of pump 102 to place pump 102 in a neutral condition, while immediately opening solenoid valve 106 via electronic connection 117, allowing any hydraulic fluid still being pumped by pump 102 to pass through hydraulic lines 108, tank 104, and hydraulic line 110, causing all movement of motor 116, gear box 118, and/or drum 18 to cease. In this manner, the fluid circuit including pump 102 and motor 116 is effectively short circuited to cause movement of drum 18 to stop.

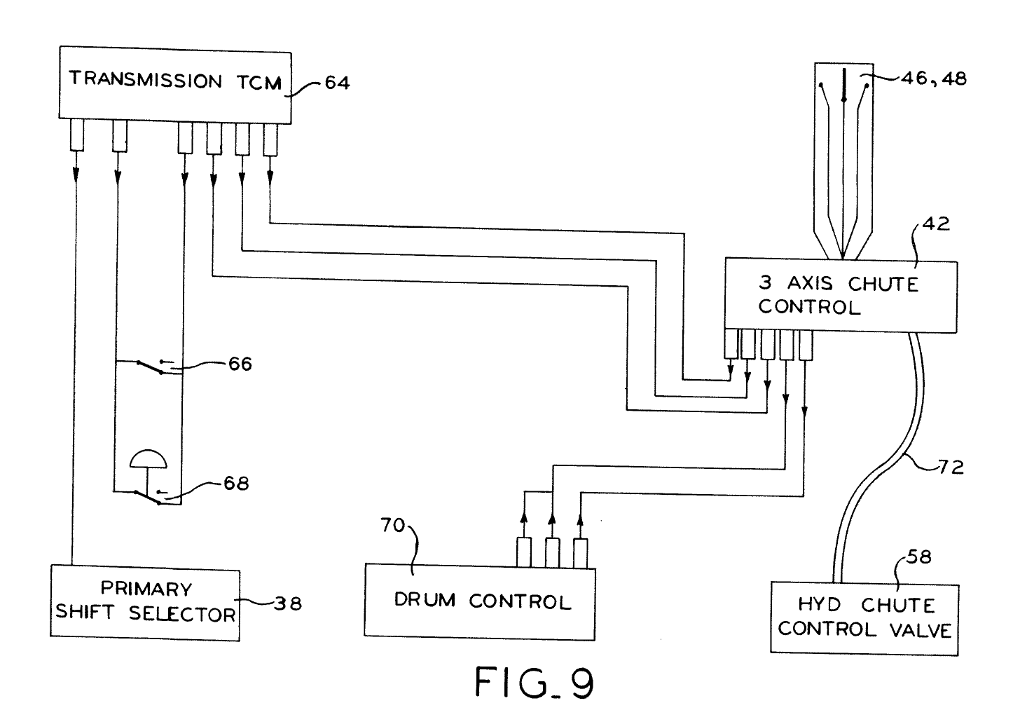

Referring to FIG. 9, another exemplary embodiment of a control system utilizing joystick 42 is shown. In this embodiment, joystick 42, and specifically, secondary shift selector 46, is directly connected to transmission control module 64. In one exemplary embodiment, the connection between secondary shift selector 46 and transmission control module 64 is an electronic connection. Additionally, in a similar manner as described above with specific reference to FIG. 4, primary shift selector 38, transmission shift select switch 66 and pressure switch 68 are also connected to transmission control module 64. Thus, as described in detail above with reference to FIG. 4, when transmission shift select switch 66 and pressure switch 68 are activated, actuation of secondary shift selector 46 results in a signal being transmitted to transmission control module 64, which controls transmission 14 and results in transmission 14 entering one of the forward condition, the reverse condition, and the neutral condition and leaving another of the forward condition, the reverse condition, and the neutral condition. In other exemplary embodiments, secondary shift selector 46 may be connected to transmission control module 64 by one of a mechanical, hydraulic, or pneumatic connection, for example.

Additionally, as shown in FIG. 9, joystick 42 is connected to chute controller 58. For example, joystick 42 may be directly connected to chute controller 56 by cables 72, for example. In this manner, actuation of joystick 42 results in corresponding actuation of cable 72, which, in turn, causes chute controller 58 to correspondingly actuate chute 22, as described in detail above. Further, joystick 42, and, specifically, drum condition selector 68 is also connected to drum control 70. In one exemplary embodiment, drum condition selector 68 is electronically connected to drum control 70. Thus, when drum condition selector 68 is actuated, a signal is sent from drum condition selector 68 to drum control 70. Responsive to the signal sent from drum condition selector 68, drum control 70 correspondingly causes actuation of drum 18 from one of the charge condition and the discharge condition to the other of the charge condition and the discharge condition. In other exemplary embodiment, drum condition selector 68 may be connected to drum control 70 by one of a mechanical, hydraulic, or pneumatic connection, for example.

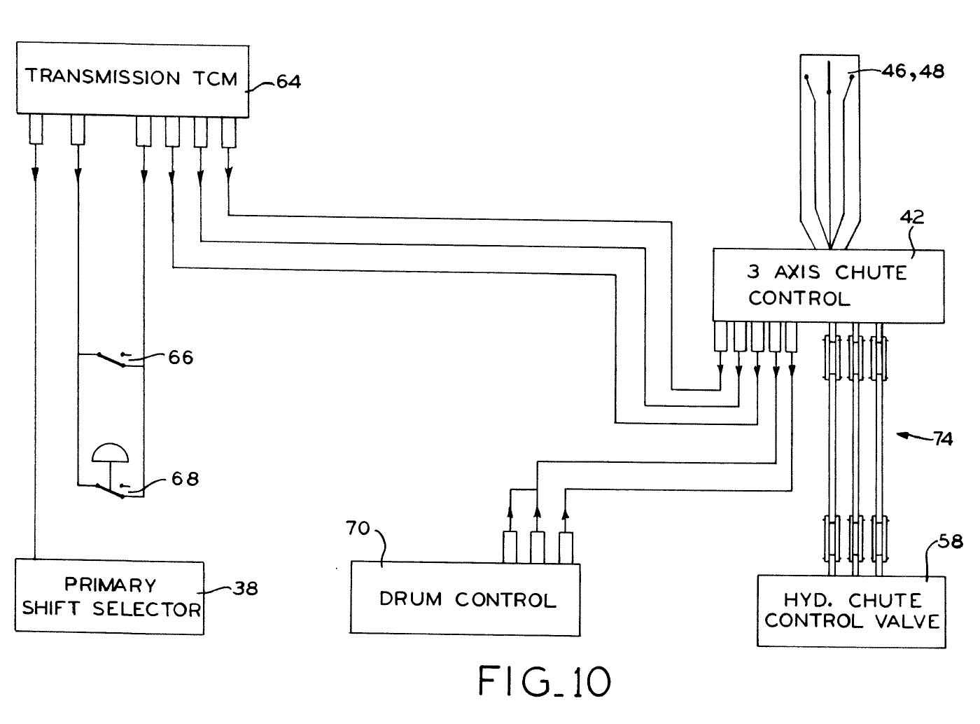

Referring to FIG. 10, another exemplary embodiment of a control system including joystick 42 is shown. In this embodiment, secondary shift selector 46 and drum condition selector 68 may be connected to transmission control module 64 and drum control 70, respectively, in a substantially similar manner as described above with reference to FIG. 9. Additionally, in this embodiment, joystick 42 is directly connected to chute controller 58. In this embodiment, joystick 42 is connected to chute controller 58 by a mechanical linkage. Thus, by actuation of joystick 42, mechanical linkage 74 is correspondingly actuated in a known manner. For example, linkage 74 may be connected to motors, servomechanisms, and/or solenoids 62 of chute controller 52. The actuation of linkage 74 activates motors, servomechanisms, and/or solenoids 62 in a manner that results in chute 22 moving into a position that corresponds to the position of joystick 42. For example, linkage 74 may be formed in a manner such as disclosed in U.S. Pat. No. 5,816,105 to Adelstein, entitled “THREE DEGREE OF FREEDOM PARALLEL MECHANICAL LINKAGE,” issued Oct. 6, 1998, and/or U.S. Pat. No. 5,316,435 to Mozingo, entitled “THREE FUNCTION CONTROL SYSTEM,” issued May 31, 1994, the entire disclosures of which are expressly incorporated by reference herein.

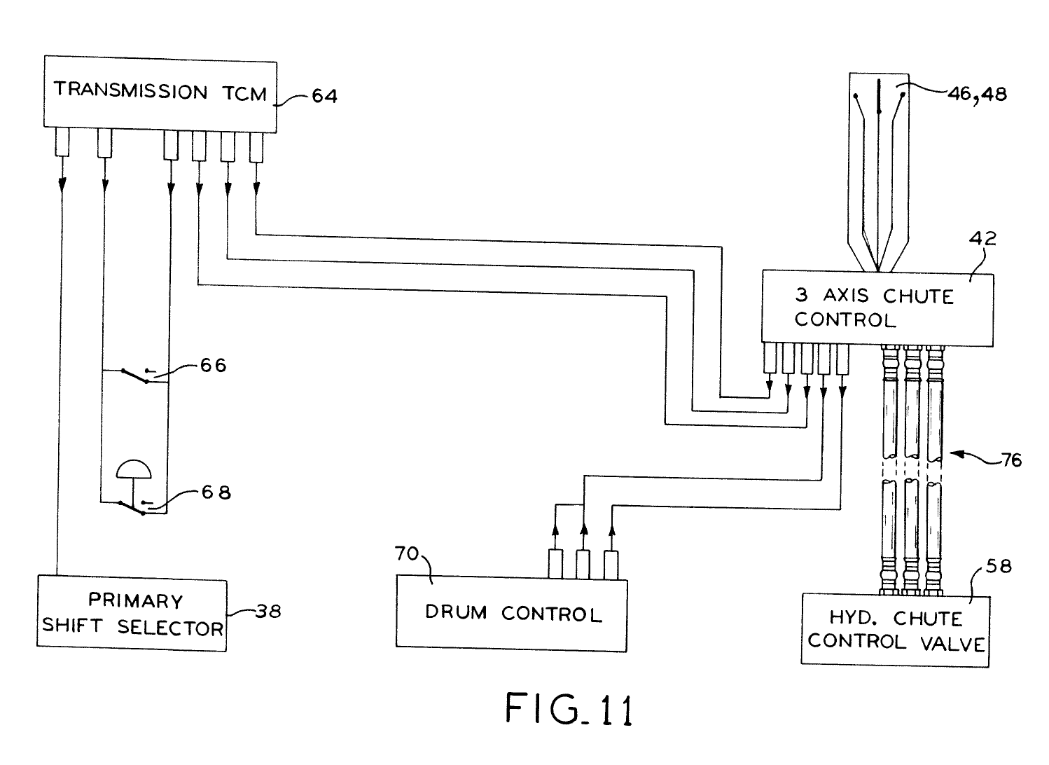

Referring to FIG. 11, another exemplary embodiment of a control system including joystick 42 is shown. In this embodiment, secondary shift selector 46 is connected to transmission control module 64 in a substantially similar manner as that shown and described with reference to FIG. 9. Additionally, in this embodiment, joystick 42 is directly connected to chute controller 58. In this embodiment, joystick 42 is connected to chute controller 58 by hydraulic connection 76. Thus, by actuation of joystick 42, a hydraulic pump and/or manifold is actuated and results in hydraulic fluid traveling through hydraulic connection 76 to chute controller 58. For example, joystick 42 may be connected to the swash plate of a hydraulic pump to cause hydraulic fluid to travel through hydraulic connection 76 to chute controller 58. In this embodiment, chute controller 58 may act to direct the hydraulic fluid as necessary to result in corresponding movement of chute 22. Thus, the actuation of joystick 42 results in hydraulic fluid traveling through hydraulic connection 76 to a chute controller 58, which actuates chute 22 to move chute 22 to a position that corresponds to the position of joystick 42.

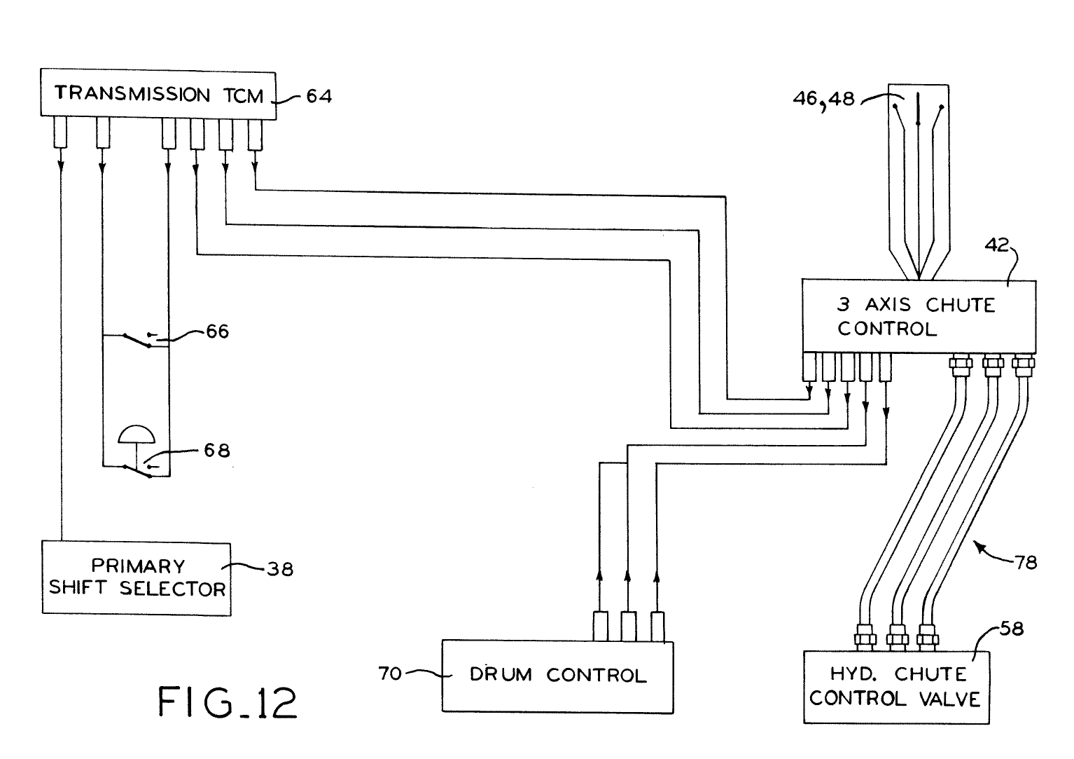

Referring to FIG. 12, another exemplary embodiment of a control system including joystick 42 is shown. In this embodiment, secondary shift selector 46 is connected to transmission control module 64 in a substantially similar manner as that shown and described with reference to FIG. 9. Additionally, in this embodiment, joystick 42 is directly connected to chute controller 58. In this embodiment, joystick 42 is connected to chute controller 58 by pneumatic connection 78. Thus, by actuation of joystick 42, a pneumatic pump and/or manifold is actuated that results in pressurized air traveling through pneumatic connection 78 to chute controller 58, which actuates chute 22 to move chute 22 to a position that corresponds to the position of joystick 42.

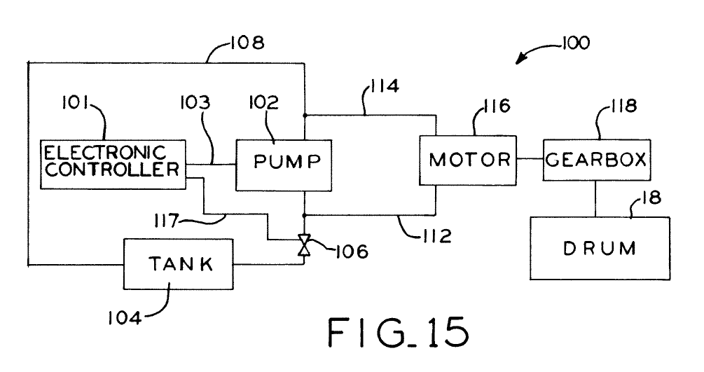

For example, actuation of joystick 42 may result in air traveling through pneumatic connection 78 and, as shown in FIG. 14, into air chamber 120 of pneumatic control 121. Specifically, referring to FIG. 14, air chamber 120 is separated into sections 122, 124 by plunger 126, which engages upper and lower walls 128, 130 defining chamber 120 to form a fluid tight seal therebetween. Plunger 126 is biased into a neutral position at the center of chamber 120 by spring 132. When air travels through pneumatic connection 78 and enters section 122 of chamber 120 through air hose 136, the biasing force of spring 132 may be overcome by plunger 126 and plunger 126 may be advanced in the direction of arrow F of FIG. 1. Alternatively, air may be received within section 124 of chamber 120 by allowing air to enter through air hose 134, causing movement of plunger 126 in the direction of arrow E of FIG. 14. By adjusting the position of plunger 126, a mechanical linkage, formed generally at 136, may be actuated to correspondingly actuate controls for motors, servomechanisms, and/or solenoids in a known manner that may control the movement of chute 22, as described in detail above.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A control device for a front discharge concrete truck, the truck including an engine, a transmission coupled to the engine, the transmission having a forward condition, a reverse condition, and a neutral condition, a chassis supporting the engine and the transmission, a rotatable drum having a discharge opening positioned on the chassis, a chute configured to receive and direct material discharged from the drum through the discharge opening, a cab positioned on the chassis substantially adjacent the discharge opening, the cab including a driver's seat, a steering wheel, and a primary shift selector positioned therein, wherein the primary shift selector is actuatable to cause the transmission to enter one of the forward condition, the reverse condition, and the neutral condition and leave another of the forward condition, the reverse condition, and the neutral condition, the control device comprising:
a joystick positioned within the cab, said joystick moveable on at least two substantially orthogonal joystick axes;
a chute controller connected to both said joystick and the chute, said chute controller operable to actuate the chute along at least two substantially orthogonal chute axes, said at least two substantially orthogonal chute axes corresponding to said at least two substantially orthogonal joystick axes, wherein actuation of said joystick along either of said at least two substantially orthogonal joystick axes results in corresponding actuation of the chute; and
a secondary shift selector positioned on said joystick, said secondary shift selector connected to the transmission, wherein actuation of said secondary shift selector results in the transmission entering one of the forward condition, the reverse condition, and the neutral condition and leaving another of the forward condition, the reverse condition, and the neutral condition.

2. The control device of claim 1, wherein said joystick comprises a lever moveable along said at least two substantially orthogonal joystick axes.

3. The control device of claim 1, wherein said joystick comprises a lever secured at a first end, said lever pivotable about said first end on said at least two substantially orthogonal joystick axes.

4. The control device of claim 1, wherein said connection between said chute controller and said joystick comprises at least one of an electronic connection, a hydraulic connection, a pneumatic connection, and a mechanical connection.

5. The control device of claim 1, wherein said connection between said chute controller and said chute comprises at least one of an electronic connection, a hydraulic connection, a pneumatic connection, and a mechanical connection.

6. The control device of claim 1, wherein said joystick is directly connected to said chute controller.

7. The control device of claim 1, wherein actuation of said joystick along either of said at least two substantially orthogonal joystick axes results in corresponding proportional actuation of the chute.

8. A front discharge concrete truck, comprising:
an engine;
a transmission coupled to the engine, said transmission having a forward condition, a reverse condition, and a neutral condition;
a chassis supporting the engine and the transmission;
a rotatable drum mounted on said chassis for holding concrete, said drum having a discharge opening, a discharge condition, and a charge condition, whereby, in said discharge condition, said drum discharges concrete through said discharge opening;
a chute configured to receive and direct concrete discharged from said drum through said discharge opening;
a cab positioned on said chassis substantially adjacent to and below said discharge opening;
a driver's seat positioned within said cab;
a steering wheel positioned within said cab;
a primary shift selector positioned within said cab, said primary shift selector connected to said transmission, wherein said primary shift selector is actuatable to cause said transmission to enter one of said forward condition, said reverse condition, and said neutral condition and leave another of said forward condition, said reverse condition, and said neutral condition;
a joystick positioned within said cab, said joystick moveable on at least two substantially orthogonal joystick axes;
a chute controller connected to both said joystick and said chute, said chute controller operable to actuate said chute along at least two substantially orthogonal chute axes, said at least two substantially orthogonal chute axes corresponding to said at least two substantially orthogonal joystick axes, wherein actuation of said joystick along either of said at least two substantially orthogonal joystick axes results in corresponding actuation of said chute; and
a secondary shift selector positioned on said joystick, said secondary shift selector connected to said transmission, wherein actuation of said secondary shift selector results in said transmission entering one of said forward condition, said reverse condition, and said neutral condition and leaving another of said forward condition, said reverse condition, and said neutral condition.

9. The front discharge concrete truck of claim 8, further comprising a transmission shift selector connected to said transmission, said transmission shift selector having a first condition wherein said primary shift selector is operable to control said transmission and a second condition wherein said secondary shift selector is operable to control said transmission.

10. The front discharge concrete truck of claim 8, further comprising a drum condition selector positioned on said joystick, said drum condition selector connected to said drum, wherein actuation of said drum condition selector results in said drum entering one of said charge condition and said discharge condition from the other of said charge condition and said discharge condition.

11. The front discharge concrete truck of claim 8, wherein said joystick comprises a lever moveable along said at least two substantially orthogonal joystick axes.

12. The front discharge concrete truck of claim 8, wherein said joystick comprises a lever secured at a first end, said lever pivotable about said first end on said at least two substantially orthogonal joystick axes.

13. The front discharge concrete truck of claim 8, wherein actuation of said joystick along either of said at least two substantially orthogonal joystick axes results in corresponding proportional actuation of said chute.

14. The front discharge concrete truck of claim 8, wherein said connection between said chute controller and said joystick comprises at least one of an electronic connection, a hydraulic connection, a pneumatic connection, and a mechanical connection.

15. The front discharge concrete truck of claim 8, wherein said connection between said chute controller and said chute comprises at least one of an electronic connection, a hydraulic connection, a pneumatic connection, and a mechanical connection.

16. The front discharge concrete truck of claim 8, wherein said joystick controller is directly connected to said chute controller.

17. A control system for a front discharge concrete truck, the truck including an engine, a transmission coupled to the engine, the transmission having a forward condition, a reverse condition, and a neutral condition, a chassis supporting the engine and the transmission, a rotatable drum having a discharge opening positioned on the chassis, a chute configured to receive and direct material discharged from the drum through the discharge opening, a cab positioned on the chassis substantially adjacent to the discharge opening, the cab including a driver's seat, a steering wheel, and a primary shift selector positioned therein, wherein the primary shift selector is actuatable to cause the transmission to enter one of the forward condition, the reverse condition, and the neutral condition and leave another of the forward condition, the reverse condition, and the neutral condition, the control system comprising:
a joystick positioned within the cab, said joystick moveable on at least two substantially orthogonal joystick axes;
a chute controller electronically connected to said joystick, said chute controller operable to actuate the chute along at least two substantially orthogonal chute axes, said at least two substantially orthogonal chute axes corresponding to said at least two substantially orthogonal joystick axes, wherein actuation of said joystick along either of said at least two substantially orthogonal joystick axes results in said joystick sending an electronic signal to said chute controller causing said chute controller to correspondingly actuate the chute in accordance with the electronic signal received from the joystick;
a transmission control module connected to the transmission, wherein said transmission control module actuates the transmission to enter one of the forward condition, the reverse condition, and the neutral condition and leave another of the forward condition, the reverse condition, and the neutral condition; and
a secondary shift selector positioned on said joystick, said secondary shift selector electronically connected to said transmission control module, wherein actuation of said secondary shift selector results in said secondary shift selector sending an electronic signal to said transmission control module and said transmission control module actuates the transmission to enter one of the forward condition, the reverse condition, and the neutral condition and leave another of the forward condition, the reverse condition, and the neutral condition in accordance with the electronic signal received from the secondary shift selector.

18. The control system of claim 17, further comprising an electronic control module, wherein said chute controller is electronically connected to said joystick via said electronic control module.

19. The control system of claim 17, further comprising an electronic control module, wherein said secondary shift selector is electronically connected to said transmission control module via said electronic control module.

20. The control system of claim 17, further comprising an electronic control module, wherein said joystick, said chute controller, said transmission control module, and said secondary shift selector are electronically connected to one another via said electronic control module.
